(19) United States
(12) Patent Application Publication
(10) Pub. No.: US 2024/0002136 A1
(43) Pub. Date: Jan. 4, 2024

(54) DEVICE FOR STORING AND DISPENSING FLOWABLE COMPOSITIONS

(71) Applicant: 3M INNOVATIVE PROPERTIES COMPANY, St. Paul, MN (US)

(72) Inventors: Marc Peuker, Schondorf am Ammersee (DE); Andreas J. Boehm, Reichling (DE); Dieter Poschmann, Starnberg (DE); Michael Knee, Peissenberg (DE); Martin Preininger, Herrsching (DE)

(21) Appl. No.: 18/038,086

(22) PCT Filed: Dec. 20, 2021
(86) PCT No.: PCT/IB2021/062045

§ 371 Date: May 22, 2023

Related U.S. Application Data
(60) Provisional application No. 63/128,434, filed on Dec. 21, 2020.

(51) Int. Cl. B65D 83/00; B65D 81/32; B65D 81/30; A61C 3/00

(52) U.S. Cl. CPC B65D 83/0094; B65D 81/3261; B65D 81/30; A61C 3/005; A61C 2202/00

(57) ABSTRACT

A device for storing and dispensing a flowable dental composition, comprising: a first layer and a second layer, wherein the first layer and second layer form a first chamber for containing a flowable dental composition, a transition zone, and a second chamber; an applicator retained within the second chamber; wherein the first chamber has a first concave surface formed in the first layer and a second concave surface formed in the second layer; wherein the device includes an inactive state and an active state.

### BACKGROUND

In the dental and orthodontic fields, it is often necessary to perform a large number of manual operations in succession and in a coordinated manner. Often various amounts of dental compositions may be necessary to use on with an individual patient. Small amounts of liquid can be stored and dispensed in receptacles in the form of blister packs. In the thermoformed part of the pack closed off by a removable film there are formed, for example, two recesses which are separate from each other. The first recess may contain a small amount of liquid, and a brush may be placed in the other recess. Examples of certain prior art packaging include the following.

WO-96/03326 discloses a disposable receptacle which has depressions for storing a medicament and an applicator. Both depressions are protected from contamination by means of a peelable covering film. In one embodiment, by pressing on the depression containing the medicament, said medicament is transferred into the depression containing the applicator in order to wet the applicator.

U.S. Pat. No. 3,835,834 discloses a treatment kit which has two depressions in a main body, which contain a care substance on the one hand and a swab on the other hand. The main body containing the care substance and the swab is protected from contamination by means of a sealing film.

EP Patent Application No. 0 895 943 discloses a device for storing and dispensing a flowable substance, with a container made up of two films which are connected to each other to form two chambers for receiving substances and a pocket which is separate from the chambers and is used for removing the mixture of the two substances, the separation between one chamber and the pocket having a transition zone that can be selectively opened. For activating the device, firstly pressure is exerted on one chamber, whereby the substance located in it is transferred into the second chamber via the transition zone. As a result, a positive pressure builds up in the second chamber and leads to bulging of one of the films forming the chambers. To prevent the mixture from flowing back into the first chamber, it is necessary for the device to be bent in the zone between the two chambers.

U.S. Pat. No. 7,320,398 discloses a device especially designed for storing and dispensing dental materials. This device comprises a container comprising a first and a second film, which form at least one first chamber for receiving a first substance and a recess that is separated from the chamber and serves to remove the first substance. The separation area between the recess and the first chamber is provided with a passage area that can be opened in a selective manner.

EP Patent No. 1240087 discloses a device for storing and dispensing a free-flowing substance.

Examples of certain dental or orthodontic products commercially available for 3M Company based in St. Paul, Minnesota include 3M™ Adper™ Prompt™ L-Pop Adhesive, 3M™ Transbond™ L-Pop Adhesive. 3M™ Clinpro L-pop Blister, 3M™ Unitek™ Transbond™ and Transbond™ Plus Self Etching Primer, 3M™ L-Pop Prime and Bond Adhesive, 3M™ Adper™ L-Pop Easy Bond Self-Etch Adhesive, 3M™ L-Pop Single Bond Universal Adhesive, 3M™ L-Pop Scotchbond™ Universal and Universal™ Plus Adhesive Unit Doses.

### SUMMARY

The disclosure relates to devices for storing and dispensing a flowable composition, and method of making the same.

In one example, the disclosure is directed to a device for storing and dispensing a flowable dental composition, comprising: a first layer and a second layer, wherein the first layer and second layer form a first chamber for containing a flowable dental composition, a transition zone, and a second chamber; an applicator retained within the second chamber; wherein the first chamber has a first concave surface formed in the first layer and a second concave surface formed in the second layer; wherein the device includes an inactive state and an active state, wherein when in the inactive state, the substance is retained in the first chamber, and wherein when in the active state, a portion of the second surface is substantially non-reversibly deformed in response to pressure applied to the first chamber and the substance is thereby dispensed through the transition zone and into the second chamber.

In another example, the disclosure is directed to a device for storing and dispensing a flowable dental composition, comprising: a first layer and a second layer, wherein the first layer and second layer form a first chamber, wherein the first chamber contains a flowable dental composition, a transition zone, and a second chamber; an applicator retained within the second chamber; wherein the first chamber has a first concave surface formed in the first layer and a second concave surface formed in the second layer; wherein the transition zone may be selectively opened by a pressure on the first chamber thereby allowing fluid communication between the first chamber, the transition zone and second chamber.

In another example, the disclosure is directed to device for storing and dispensing a flowable dental composition, comprising: a first layer and a second layer, wherein the first layer and second layer form a first chamber containing a flowable dental composition, a second chamber, and a transition zone; and an applicator retained within the second chamber; wherein the first chamber has a first concave surface formed in the first layer and a second concave surface formed in the second layer; wherein the device includes an inactive state and an active state, wherein when in the inactive state, a first volume of the dental composition is retained in the first chamber, and wherein when in the active state, a second volume of the dental composition in the first chamber is less than the first volume.

In yet another example, the disclosure is directed to a device for storing and dispensing a flowable dental composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; and a light disruption portion for protecting the flowable dental composition from prematurely curing.

In another example, the disclosure is directed to a device for storing and dispensing a flowable dental composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; wherein the second concave surface is substantially non-reversibly deformed in response to pressure applied to the first chamber and forms a smooth convex surface aligned with the first concave surface.

In another example, the disclosure is directed to a device for storing and dispensing a flowable orthodontic composition, comprising: a first layer and a second layer, wherein the first layer and second layer form a first chamber for containing a flowable dental composition, a transition zone, and a second chamber; an applicator retained within the second chamber; wherein the first chamber has a first concave surface formed in the first layer and a second concave surface formed in the second layer; wherein the device includes an inactive state and an active state, wherein when in the inactive state, the substance is retained in the first chamber, and wherein when in the active state, a portion of the second surface is substantially non-reversibly deformed in response to pressure applied to the first chamber and the substance is thereby dispensed through the transition zone and into the second chamber.

In yet another example, the disclosure is directed to a device for storing and dispensing a flowable orthodontic composition, comprising: a first layer and a second layer, wherein the first layer and second layer form a first chamber, wherein the first chamber contains a flowable dental composition, a transition zone, and a second chamber; an applicator retained within the second chamber; wherein the first chamber has a first concave surface formed in the first layer and a second concave surface formed in the second layer;

wherein the transition zone may be selectively opened by a pressure on the first chamber thereby allowing fluid communication between the first chamber, the transition zone and second chamber.

In another example, the disclosure is directed to a device for storing and dispensing a flowable orthodontic composition, comprising: a first layer and a second layer, wherein the first layer and second layer form a first chamber containing a flowable dental composition, a second chamber, and a transition zone; and an applicator retained within the second chamber; wherein the first chamber has a first concave surface formed in the first layer and a second concave surface formed in the second layer; wherein the device includes an inactive state and an active state, wherein when in the inactive state, a first volume of the dental composition is retained in the first chamber, and wherein when in the active state, a second volume of the dental composition in the first chamber is less than the first volume.

In another example, the disclosure is directed to device for storing and dispensing a flowable orthodontic composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; and a light disruption portion for protecting the flowable dental composition from prematurely curing.

In another example, the disclosure is directed to a device for storing and dispensing a flowable orthodontic composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; wherein the second concave surface is substantially non-reversibly deformed in response to pressure applied to the first chamber and forms a smooth convex surface aligned with the first concave surface.

In yet another example, the disclosure is directed to method of making a device for storing and dispensing a flowable dental or orthodontic composition. The method comprising: providing a first layer; cold forming the first layer, thereby partially forming a first and second chambers; filling of the first chamber with the flowable dental or orthodontic composition; providing a second layer; cold forming the second layer, thereby partially forming the first and second chambers; sealing the second layer to the first layer in surface-area contact, leaving the first and second chambers open, forming a dispensing zone, and forming a transition zone that can be selectively opened between the first and second chambers and in the dispensing zone; dye cutting the desired shape of the device; and partially cutting the first and second layers with a cut for a light disruption portion.

### BRIEF DESCRIPTION OF THE DRAWINGS

FIG. 1 is a top, schematic view of an exemplary device for storing and dispensing a flowable dental composition;

FIG. 2 is a cross-sectional, schematic view of the device of FIG. 1 taken along line A-A;

FIGS. 3A-3C are cross-sectional, schematic views of the device of FIG. 1 taken along line A-A, illustrating the steps of dispensing the flowable composition from the first chamber into the second chamber of the device;

FIG. 4 is an enlarged, cross-sectional, schematic view of the first layer and second layer of the device;

FIG. 5 is an enlarged, cross-sectional, schematic view of the first layer and second layer including an exemplary light disruption portion;

FIG. 6 is an enlarged, cross-sectional schematic view of the device of FIG. 5;

FIG. 7 is a top view of an intermediate manufacturing step of the devices 10 of the present invention;

FIG. 8 is a photograph illustrating the differences between prior art devices and the devices of the present invention;

FIGS. 9A-9C are top, schematic view of additional exemplary devices for storing and dispensing a flowable dental composition;

FIG. 10 is a cross-sectional, schematic view of the device for storing and dispensing a flowable dental composition;

FIG. 11 is a cross-sectional view of yet another exemplary device for storing and dispensing a flowable dental composition; and

FIGS. 12A-12D are cross-sectional, schematic views of the device of FIG. 11 illustrating the steps of dispensing the flowable composition from the first chamber into the second chamber of the device;

### DETAILED DESCRIPTION

3M Company's popular L-Pop™ Adhesive line of products have provided single step, unit-dose adhesives or primers for both dental and orthodontic uses. Its unique packaging kept contents divided into two compartments during storage, until the dental professional was ready to etch, prime and bond in a single step by mixing the contents together.

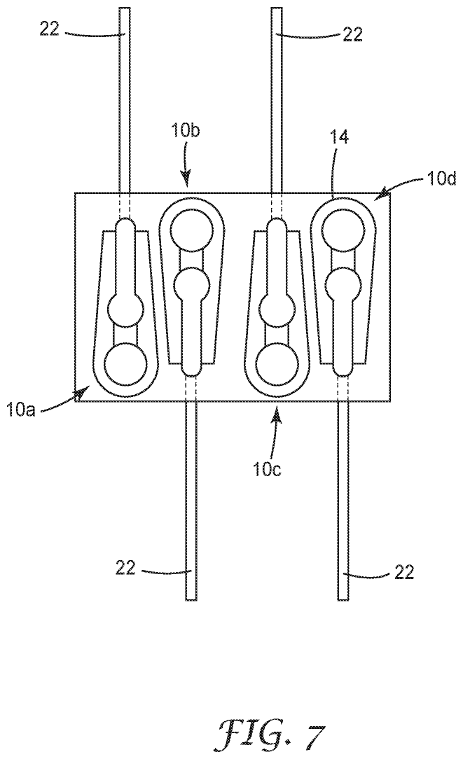

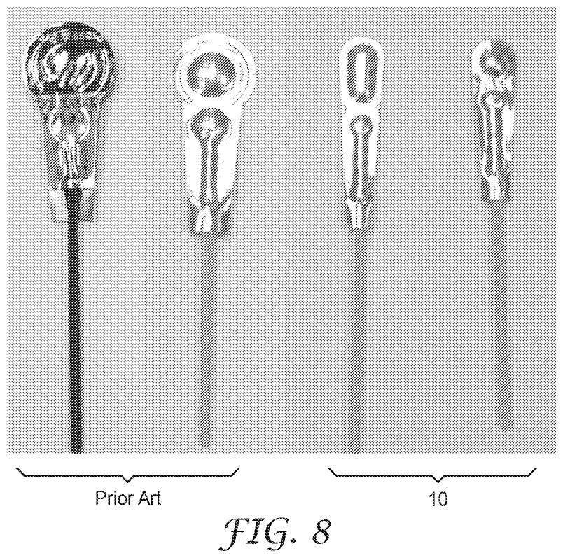

The present invention focuses on the sustainable or environmental aspects of a similar L-pop design. In the newly redesigned embodiments, the materials for the layers or laminate foils are reduced up to 50% compared to conventional L-pop products. For example, the present invention reduces the amount of laminate foils necessary to make the device from 0.24 g to 0.12 g. FIG. 8 illustrates the size difference between prior art L-pop designed products by 3M, shown as the left two items and the new design of the present invention, shown as the right two embodiments, discussed more below. In addition, manufacturing production may be almost doubled, while only using nearly the same amount of material. FIG. 7 helps illustrate this aspect, also discussed more below.

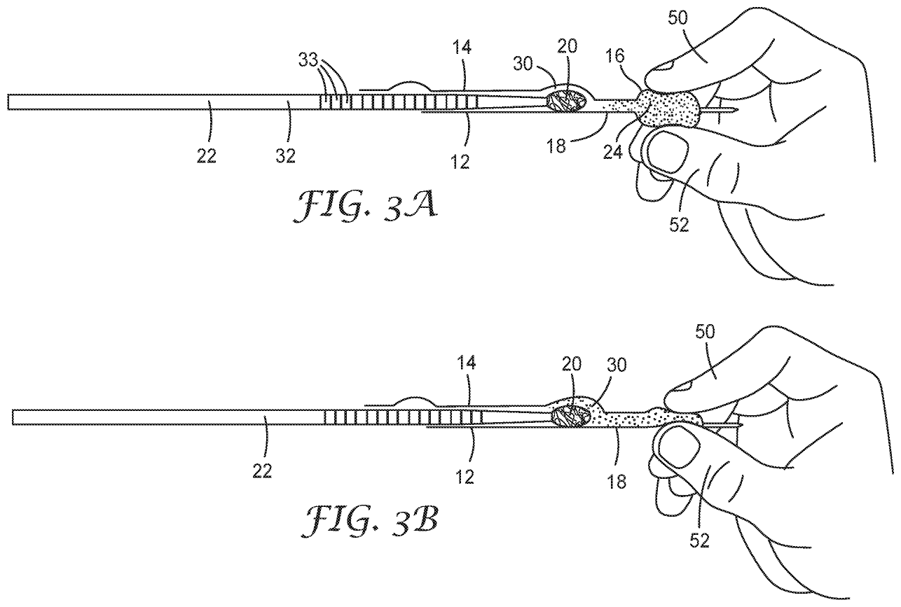

Also, the geometry of the packaging of the present invention has been redesigned to decrease the likelihood of laminate or layer wrinkles occurring in the liquid storage chamber, thereby maximizing the amount of flowable dental or orthodontic composition stored and then dispensed from the chamber or compartment. The absences of layer wrinkles also minimizes unused contents left in the chamber, as illustrated in FIG. 3C. Lastly, the present invention includes a unique light disruption feature, which avoids premature aging (chemical degradation) or prematurely curing of the stored dental substance.

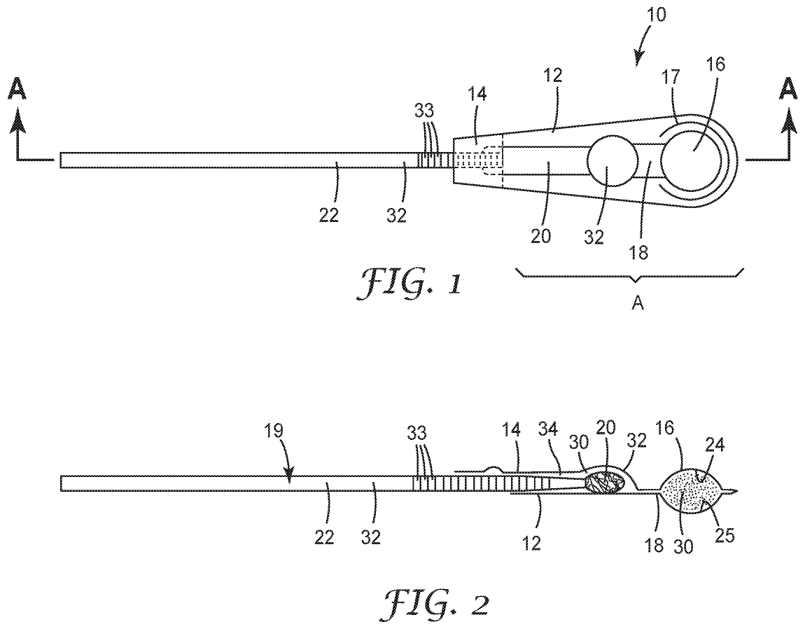

An exemplary device 10 of the present invention is illustrated in FIGS. 1 and 2. In these Figures, the device is in an inactive state. For example, this is how the device may be stored prior to use. FIGS. 3A-3C illustrate the device 10 of the present invention in an active state. For example, illustrating the device 10 while in use.

The device 10 includes a first layer 12 and a second layer 14. Each layer 12, 14 preferably is a laminated foil, which is made from both plastic layers and metal foil. The two layers 12, 14 are sealed to each other in a peelable manner, and form a first chamber 16 and a second chamber 32. The first chamber is formed by a portion of the first layer 12 having a first concave surface 25 and a portion of the second layer 14 having a second concave surface 24 opposite the first concave surface 25. Each concave surface is viewed relative to the side view of the horizontal axis A-A running the length of the device 10 or alternatively from the view of the composition 30 filled into the chamber. The description of the form of a layers 12, 14 as “concave” or “convex” does not, however, exclude the possibility of the layer changing its curvature characteristics, in particular in edge zones.

A flowable composition 30, preferably a flowable dental or orthodontic composition is housed in the first chamber 16 during the device's inactive state. Examples of flowable dental composition 30 may include adhesives, flowable composites, cements, liners, sealants, caries indicators, desensitizers, caries arrest liquids. Examples of flowable orthodontic compositions also include adhesives. The layers 12, 14 are formed to accommodate the volume of the composition 30 in the first chamber 16. In some embodiments the composition 30 may be exposed to ambient light entering the first chamber 16 via a light pathway between layers 12 and 14. In some embodiments the entrance of ambient light into chamber 16 may occur when layers 12 and 14 further include clear or translucent seal layers; such seal layer(s) may form a kind of light guide or light pathway.

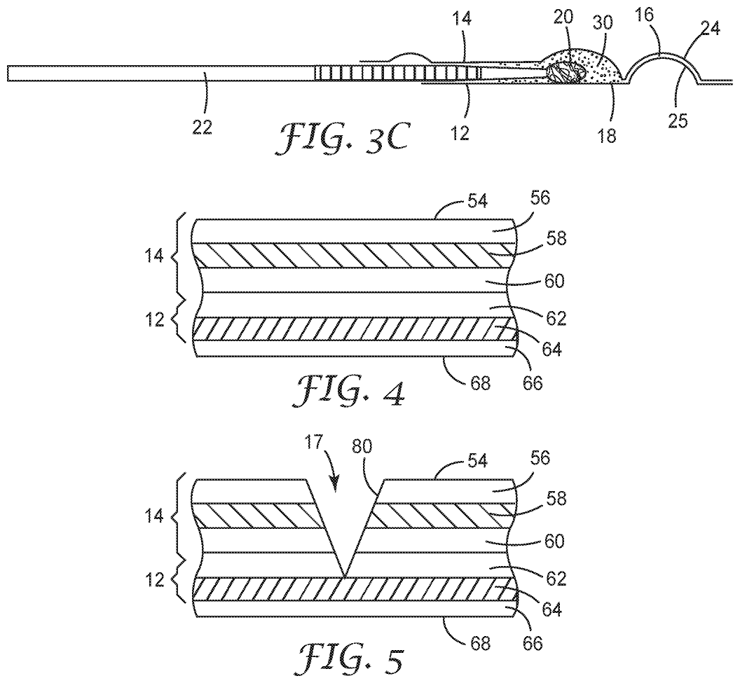

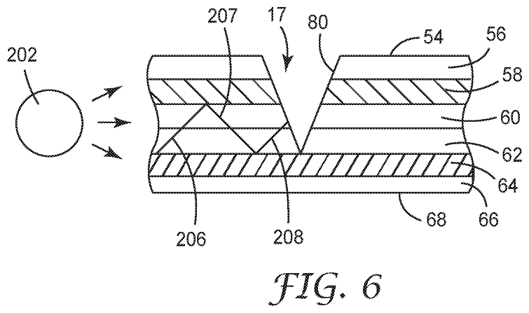

In other words, light propagates by total internal reflection within lightguide until reaching the chamber 16 and the composition 30 contained therein. Due to the possibility of premature curing of the dental compositions 30, while the device 10 is in storage, the device preferably includes a light disruption portion 17. Light disruption portions 17 may come in many forms. One exemplary form is a cut portion 80, described in more detail below relative to FIGS. 5 and 6.

The two layers 12, 14 also form a transition zone that can be selectively opened, by having peel ability in a predetermined breaking zone located between a first chamber 16 and a second chamber 32 formed between the two layers 12, 14. The two layers 12, 14 also form a dispensing zone 34, which retains an applicator 19. The applicator includes an applicator head 20 mounted on the end of a handle 22. The handle 22 may include optional grip assist portions 33. The head 20 is retained within the second chamber 32. The second chamber 32 is shaped to have a relatively flat base and an convex covering portion covering the head 20.

As illustrated in FIGS. 3A-3C, the device 10 is activated by exerting external pressure on the first chamber 16. A user may activate the device from its inactive state into an active state by applying external pressure, by way of the user's index finger 50 and thumb 52. In this respect, the device is activated by such pressure being exerted on the first chamber 16, whereby the composition 30 located in the first chamber 16 is transferred into the second chamber 32 via the transition zone 18 which is being selectively opened by the fluid pressure and the flow of the composition 30 between the first layer 12 and second layer 14 in such zone. The transition zone 18 that can be selectively opened consequently represents, as it were, a kind of predetermined breaking point, at which first chamber 16 opens and composition 30 flows through the transition zone 18 and into the second chamber 32. The transition zone 18 is designed such that, in the storage state or inactive state, it forms a sealed closure, both between the two chambers 16, 32 and with respect to the zone 34 via which the composition 30 is to be dispensed.

The chambers 16, 32 are preferably formed such that they are round (circular or oval, etc.) but, if appropriate, also could be angular (square, rectangular or triangular, etc. with rounded or sharp edges). Preferably, first chamber 16 is hermetically sealed along its entire circumference. The activation of the device 10 is capable of being seen visually by exerting pressure on the first chamber 16.

The dispensing zone 34 is preferably formed such that it is open towards one side, i.e. pocket-like, and formed such that a dispensing instrument or an applicator 19 can be introduced in the inactive or storing state. The applicator 19 is preferably designed like a brush or a swab. Alternatively, pipettes, cotton sticks, sponges, spatulas or spray heads sealed into the dispensing zone 34 could be used as an application instrument or as application device.

When the device 10 is in the active state and the dental composition flows into the second chamber 32, the applicator 19 located in the dispensing zone 34 is wetted and can subsequently be used for applying the released dental composition 30. It is also possible for the applicator 19 be moved in the direction of the first chamber 16, to release the transition zone 18 that can be selectively opened. This likewise results in the head 20 of the applicator 19 being wetted. If repeated application of the released substance is necessary, the applicator 19 can be re-inserted into the pocket dispensing zone 34. The dispensing zone 34 or the applicator 19 is preferably designed such that, when it is re-inserted, wetting of the majority of the handle 22 of the applicator 19 does not take place. This may happen, for example, by a channel-shaped formation of the dispensing zone 34 and a matching formation of the applicator handle 22. Also, the second layer 14 may be configured in a dish-shaped or well-shaped manner in the dispensing zone, into which the substance is conveyed for repeated wetting of the applicator 19 without wetting the handle 22 by squeezing out the second chamber in a way similar to in the case of tubes.

The dispensing zone 34 may also serve as an application device itself if there is a correspondingly small diameter of the opening towards the outside, for example in the form of a cannula.

Preferably, the two layers 12, 14 are cold formed to provide the design as described above. For example, cold forming may involve placing layers 12, 14 containing the metal foils within a die and squeezing the two layers together into a formed by the die, while the metal in the die is at room temperature or below the metal foils recrystallization temperature, to form the desired shape or configuration within the layers.

With the exception of the areas forming the chambers 16, 32, the layers 12, 14 are preferably connected to one another in surface-to-surface area contact. As an alternative, the connection of the first layer 12 to the second layer 14 may take place, for example, by heat-sealing, adhesive bonding and/or ultrasonic welding with sonotrodes. The first and second layers 12, 14 are adhered together in the inactive state in the transition zone 18 and around the first and second chambers 16. 26. In this state, the transition zone 18 has a reduced adherence between the first and second layers 12, 14 compared to the other areas around the first and second chambers 16, 32.

When the device 10 is in an inactive state, the first cold-formed, internal surface 24 of first chamber 16 is concave and the second cold-formed, internal surface 25 of first chamber 16 is concave. When the device 10 is in an active state, the first cold-formed, internal surface 24 of first chamber 16 remains concave from the internal perspective, and the second cold-formed surface 25 is deformed convex. Or, both layers 12, 14 are round or something in between such as partly convex and partly concave, but always in nearly full surface contact with each other). Regardless, the flowable dental composition 30 is thereby dispensed from the first chamber 16 through the transition zone 18. By surface 24 and surface 25 having matching surface areas, the complete expulsion of composition 30 from chamber 16 is readily facilitated when surface 25 is deformed convexly to match and mate with surface 24 remaining in the concave configuration. This is possible because both surfaces 24, 25 were previously cold-formed. One illustration of this phenomena is in FIG. 3C.

FIGS. 4 and 5 illustrate an exemplary device 10 having multilayer layers 12, 14. Both the first layer 12 and the second layer 14 have three layers. The second layer 14 has a top layer 56, and the first layer 12 has a bottom layer 66. Both layers 56, 66 may be made of clear materials. Examples of suitable materials for the clear materials in layers 56, 66 include polyethylene (PE), polypropylene (PP), polyethylene terephthalate (PET), polyamide (PA), polyvinyl chloride (PVC), ethylene vinyl alcohol (EVA), and PVF (polyvinyl fluoride). The second layer 14 includes a foil layer 58 adjacent the top layer 56. The first layer 12 has a foil layer 64. The middle foil layers 58, 64 are metallic foil, preferably aluminum. The first layer 12 also includes a film or seal layer 62. Examples of suitable film or seal layers 60 and 62 include polymeric and/or adhesive films. In some embodiments the polymeric seal layers 60 and 62 are clear or translucent. In those embodiments where one or both of seal layers 60 and 62 are clear or translucent the phenomenon of a light guide may occur between foil layers 58, 64, when layers 58 and 64 are at least partially reflective, as in the case of being aluminum.

The first layer also includes a film or seal layer 60. The second layer 14 also includes a film or seal layer 62. Examples of suitable film or seal layers 60 and 62 include polymeric and/or adhesive layers. In some embodiments the polymeric seal layers 60 and 62 are clear or translucent. In those embodiments where one or both of seal layers 60 and 62 are clear or translucent the phenomenon of a light guide may occur between foil layers 58, 64 when layers 58 and 64 are at least partially reflective, as in the case of being metallic foil, such as aluminum. Examples of suitable seal layers include polyethylene (PE), polypropylene (PP), polytetrafluoroethylene (PTFE), polyethylene terephthalate (PET), polyamide (PA), polybutylene terephthalate (PBT), polyvinyl chloride (PVC), ethylene vinyl alcohol (EVA), and PVF (polyvinyl fluoride).

As mentioned above, the device preferably includes a light disruption portion 17. FIG. 5 illustrates one example of such a light disruption portion 17 (As illustrated, the light disruption portion 17 includes a cut portion 80. Alternatively, the cut 80 also could come from the opposite side starting at layer 12). The cut portion 80 serves as a disruption of the potential light guide of any ambient light or direct light outside of the device 10. The light is directed through the film layers, 60, 62 and internally reflects between metal foil layers 58 and 64. In a preferred embodiment, illustrated in FIG. 1, the cut portion 80 may be shaped to partially surround the first chamber 16. This light disruption portion 17 helps prevent any premature curing or aging of the dental composition stored in the first chamber 16, particularly those compositions which are photo-cured, for example cured by UV curing lights. In addition, the layers 12, 14 may include layers having adequate diffusion impermeability. Other embodiments of light disruption portions 17 include the carbon black materials in layer 60 and/or layer 62. In some other embodiments, light disruption portion 17 may include coating the aluminum layer(s) 58 and/or 64 with carbon black. In some embodiments light disruption portion 17 may include doping layers, 60 and 62 with carbon black or other additives to disrupt the internal reflection of light between foil layers 58 and 64.

FIG. 6 shows a schematic cross section of the exemplary light disruption portion 17 in use with a light source 202 Ambient light schematically illustrated by light source 202 is positioned relative to the device 10 such that light emitted by the light source enters the layer 12, 14 and is transported within the device by total internal reflection. Light will not enter through the top or bottom of the device 10 due to the metallic foil, such as aluminum, or otherwise opaque layers 58, 64, which reflects the light outward from the device. Ambient light emitted by the light source is represented by rays externally, and then are represented by single rays 206, 207, 208, which are transported by total internal reflection. The light disruption portion 17 which in this case is the cut portion 80 serves to stop the propagation of internal reflection of the light ray 208. Additionally, the process of creating cut portion 80 may also create deformations (not shown) in one or both of layers 58 and 64; such deformations in the form of slight bends and wrinkles may themselves provide the primary functionality of light disruption portion 17. As a result, the composition 30 is protected from such light rays. As illustrated in FIG. 1, the cut portion 80 encircles the first chamber 16 containing the composition 30 to provide such protection.

The multilayer construction of the first and second layers 12, 14 can be achieved by laminating, calendaring, laminating of various layers comprising single layers, if appropriate also by vapor-depositing, for example with metals such as aluminum. Also, depending on the application area and the desired deformability, the layers 12, 14 are stretched or are in an unstretched state before the activation of the device 10. The layers may be chosen from plastic layers, metal foils and ceramic sheets. Suitable plastic layers are, for example: PE, PP, PTFE, PET, PA, PBT, PVC, EVA, PVF (polyvinyl fluoride). Suitable metal foils are, for example: aluminum (Al), tin (Sn), gold (Au), silver (Ag), iron (Fe) based such as steel, and lead (Pb). Suitable ceramic sheets are to be understood as meaning layers which have, for example, a layer containing SiOx.

The volume of the first chamber 16 usually lies in the range from 5 to 500 μl, preferably in the range from 10 to 250 μl. The volume of the second chamber 32 is preferably less than or equal to the volume of the first chamber, at least before the activation of the device, and lies in the range from 3 to 500 μl, preferably in the range from 5 to 250 μl. The first chamber 16 has, for example, a diameter from 1 to 25 mm, preferably in the range from 5 to 15 mm. The second chamber 32 has, for example, a diameter from 1 to 25 mm, preferably in the range from 5 to 15 mm.

The device 10 can be produced, for example, by the following method: a) providing a first layer 12; b) cold forming the first layer 12, thereby partially forming the first and second chambers 16, 32; c) filling of the first chamber 16 with the flowable dental composition 30; d) providing a second layer 14; e) cold forming the second layer 14, thereby partially forming the first and second chambers 16, 32; f) sealing the second layer 14 to the first layer 12 to a great extent in surface-area contact, leaving the chambers 16, 32 free and forming a transition zone 18 that can be selectively opened between the two chambers 16 and 32 and in the dispensing zone 34; g) dye cutting the outer contour or desired shape of the device; and h) cutting the layers with cut 80 for the light disruption portion 17. For the sealing step, this may be done in two phases. The first phase seals the two layers 12, 14 together, but they are still peelable. The second phase seals the two layers 12, 14 together, making them unpeelable in all areas except for the transition zone 18 and the open chambers 16, 32.

FIG. 7 illustrates an intermediate step in the manufacturing process described above. In FIG. 7, steps a)-f) have been completed. To achieve the objective of making a more sustainable and environmentally friendly device, the devices 10a-10d are arranged as illustrated so as to optimize the use of the materials. This arrangement helps increase the manufacturing production.

FIG. 8 is a photograph illustrating a side-by-side comparison of the prior art L-Pop design, in particular the 3M™ Scotchbond™ Universal L-Pop adhesive (left two images, front and back), compared to the present inventive device 10 (right two images, front and back). FIG. 8 is a photograph illustrating the differences between a prior art device (both on the left side are prior art) and the devices of the present invention without a light disruption portion 17.

The devices 10 are illustrated with different shapes for the first chamber 16. In this case, the first chamber 16 are ovals or circles. However, the first chamber 16 may be any shape desired.

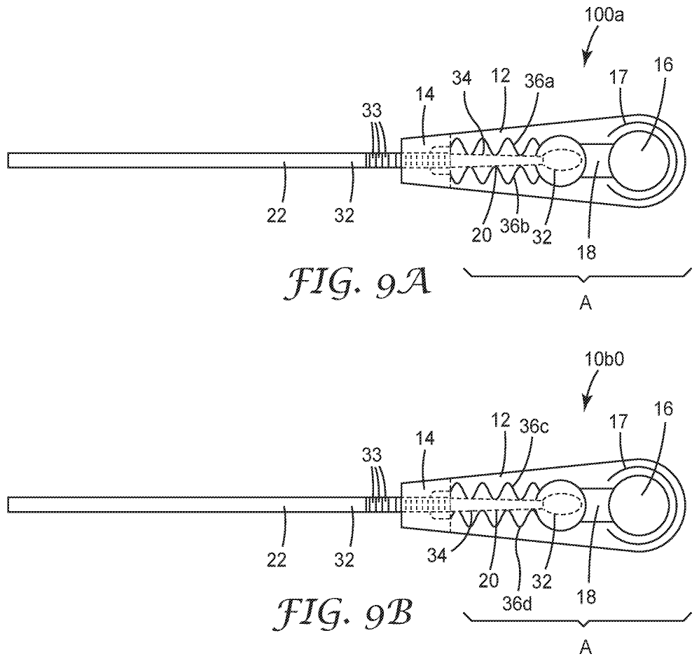

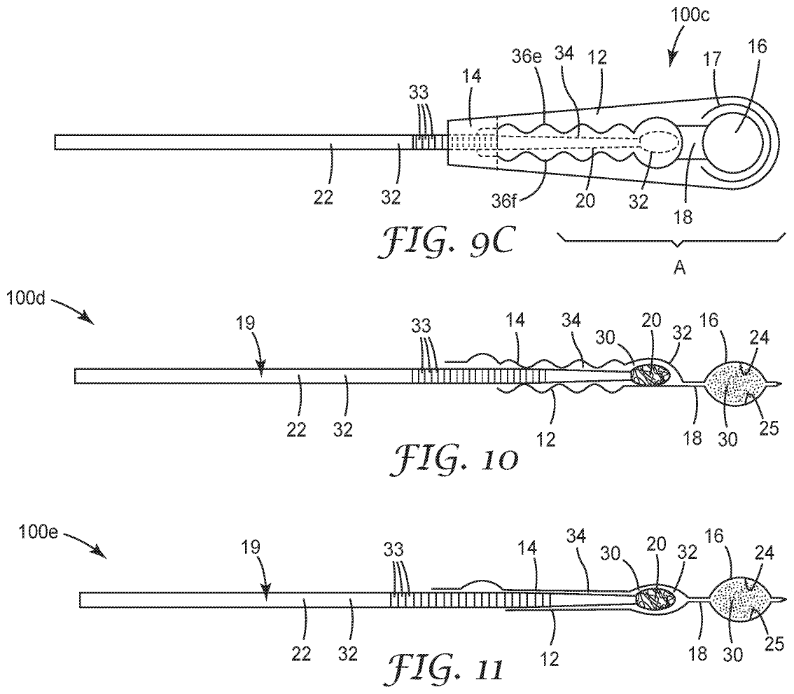

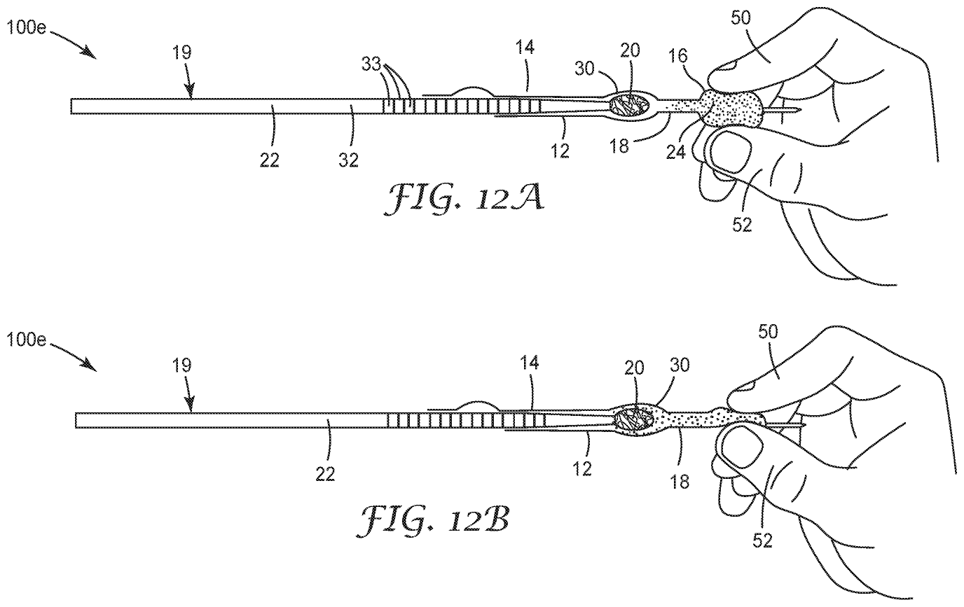

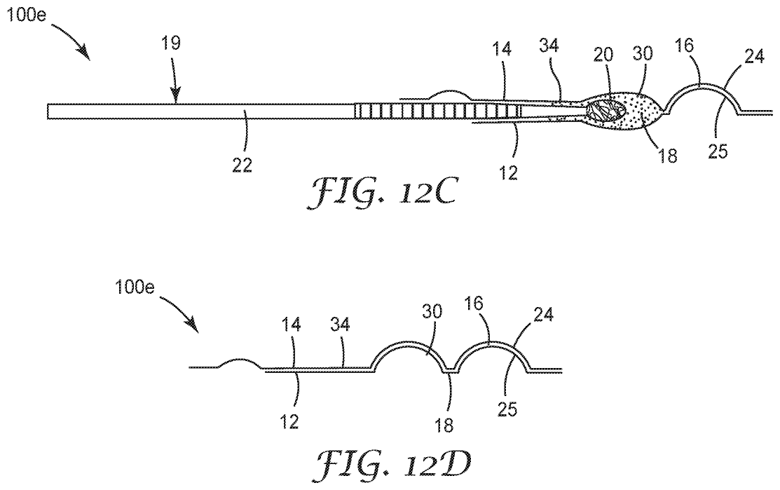

Other exemplary devices 100 of the present invention are illustrated in FIGS. 9A-9C, 10 and 11. In these Figures, the device 100 is in an inactive state. For example, this is how the device 100 may be stored prior to use. FIGS. 12A-12D illustrate the one of the devices 100e of the present invention in an active state. For example, illustrating the device 100e while in use.

Device 100a, 100b, 100c, 100d, and 100e are very similar to the devices 10 shown in the prior Figures, except that each device includes optional flow barriers 36 in the dispensing zones 34. The flow barriers 36 help avoid excess flowable dental composition accidently splashing out of the dispensing zone 34 during activation of the device 100 or while the brush head 20 is pulled by the applicator 22 out of the second chamber 32. Instead, the flow barriers allow some of the excess composition 30 to be swiped away from the saturated brush head 20, thus allowing a user to apply the composition 30 in a more controlled manner and to leave unnecessary composition 30 within the device 100. The flow barriers 36 can also improved the fit of the brush head 20 and handle 22 within the dispensing zone 34 and second chamber 30 to help prevent the applicator 19 from accidently falling out of the device 100.

Similar to device 10 described above, device 100a-e includes a first layer 12 and a second layer 14. Each layer 12, 14 preferably is a laminated foil, which is made from both plastic layers and metal foil. The two layers 12, 14 are sealed to each other in a peelable manner, and form a first chamber 16 and a second chamber 32. The first chamber is formed by a portion of the first layer 12 having a first concave surface 25 and a portion of the second layer 14 having a second concave surface 24 opposite the first concave surface 25. Each concave surface is viewed relative to the side view of the horizontal axis A-A running the length of the device 10 or alternatively from the view of the composition 30 filled into the chamber. The description of the form of a layers 12, 14 as “concave” or “convex” does not, however, exclude the possibility of the layer changing its curvature characteristics, in particular in edge zones.

The layers 12, 14 are formed to accommodate the volume of the composition 30 in the first chamber 16. The two layers 12, 14 also form a transition zone 18 that can be selectively opened, by having peel ability in a predetermined breaking zone located between a first chamber 16 and a second chamber 32 formed between the two layers 12, 14. The two layers 12, 14 also form a dispensing zone 34. The dispensing zone 34 is formed by flow barriers 36 which are areas where the two layers 12, 14 are sealed forming a pocket there between to retain shaft 32 of the applicator 22.

In the embodiments illustrated in FIGS. 9A-9C, the dispensing zone 34 may take many forms. In FIG. 9A, the dispensing zone 34 in device 100a includes a first flow barrier 36a and a second flow barrier 36b. In this embodiment, the flow barriers 36a, 36b are in opposite sine wave configurations. In FIG. 9B, the dispensing zone in device 100b has flow barriers 36c, 36d in aligned sine wave configurations. FIG. 9C illustrates a device 100c having a dispensing zone 34 with flow barriers 36e, 36f in an opposite sine wave configurations stretched out to have less peaks and valleys.

FIG. 10 illustrates yet another embodiment for a dispensing zone 34. Instead of having a relatively flat base for the first film 12 as illustrated in the prior Figures, FIG. 10 includes curved first film 12 and a curved second film 14 in the dispensing zone 34. The curved flow barriers are aligned perpendicular to the axis of the applicator 19.

FIG. 11 illustrates an alternative device 100 that is very similar to the devices described previously, but the first film 12 in this device 100e is not completely flat, as illustrated in FIG. 3. Instead, the first film in device 100e is more loose and concave, thus forming a more symmetrical second chamber 30.

As illustrated in FIGS. 12A-12D, the device 100e is activated by exerting external pressure on the first chamber 16. A user may activate the device from its inactive state into an active state by applying external pressure, by way of the user's index finger 50 and thumb 52. In this respect, the device is activated by such pressure being exerted on the first chamber 16, whereby the composition 30 located in the first chamber 16 is transferred into the second chamber 32 via the transition zone 18 which is being selectively opened by the fluid pressure and the flow of the composition 30 between the first layer 12 and second layer 14 in such zone. The transition zone 18 that can be selectively opened consequently represents, as it were, a kind of predetermined breaking point, at which first chamber 16 opens and composition 30 flows through the transition zone 18 and into the second chamber 32. The transition zone 18 is designed such that, in the storage state or inactive state, it forms a sealed closure, both between the two chambers 16, 32 and with respect to the zone 34 via which the composition 30 is to be dispensed.

The chambers 16, 32 are preferably formed such that they are round (circular or oval, etc.) but, if appropriate, also could be angular (square, rectangular or triangular, etc. with rounded or sharp edges). Preferably, first chamber 16 is hermetically sealed along its entire circumference. The activation of the device 10 is capable of being seen visually by exerting pressure on the first chamber 16.

The dispensing zone 34 is preferably formed such that it is open towards one side, i.e. pocket-like, and formed such that a dispensing instrument or an applicator 19 can be introduced in the inactive or storing state. The applicator 19 is preferably designed like a brush or a swab. Alternatively, pipettes, cotton sticks, sponges, spatulas or spray heads sealed into the dispensing zone 34 could be used as an application instrument or as application device.

When the device 10 is in the active state and the dental composition flows into the second chamber 32, the applicator 19 located in the dispensing zone 34 is wetted and can subsequently be used for applying the released dental composition 30. It is also possible for the applicator 19 be moved in the direction of the first chamber 16, to release the transition zone 18 that can be selectively opened. This likewise results in the head 20 of the applicator 19 being wetted. If repeated application of the released substance is necessary, the applicator 19 can be re-inserted into the pocket dispensing zone 34. The dispensing zone 34 or the applicator 19 is preferably designed such that, when it is re-inserted, wetting of the majority of the handle 22 of the applicator 19 does not take place. This may happen, for example, by a channel-shaped formation of the dispensing zone 34 and a matching formation of the applicator handle 22. Also, the second layer 14 may be configured in a dish-shaped or well-shaped manner in the dispensing zone, into which the substance is conveyed for repeated wetting of the applicator 19 without wetting the handle 22 by squeezing out the second chamber in a way similar to in the case of tubes.

Preferably, the two layers 12, 14 are cold formed to provide the design as described above. For example, cold forming may involve placing layers 12, 14 containing the metal foils within a die and squeezing the two layers together into a formed by the die, while the metal in the die is at room temperature or below the metal foils recrystallization temperature, to form the desired shape or configuration within the layers.

When the device 10 is in an inactive state, the first cold-formed, internal surface 24 of first chamber 16 is concave and the second cold-formed, internal surface 25 of first chamber 16 is concave. Likewise, in the inactive state, the internal surface 24 and internal surface 25 of the second chamber 30 are both concave. When the device 10 is in an active state, the first cold-formed, internal surface 24 of first chamber 16 remains concave from the internal perspective, and the second cold-formed surface 25 is deformed convex. Or, both layers 12, 14 are round or something in between such as partly convex and partly concave, but always in nearly full surface contact with each other. Regardless, the flowable dental composition 30 is thereby dispensed from the first chamber 16 through the transition zone 18. By surface 24 and surface 25 having matching surface areas, the complete expulsion of composition 30 from chamber 16 is readily facilitated when surface 25 is deformed convexly to match and mate with surface 24 remaining in the concave configuration. This is possible because both surfaces 24, 25 were previously cold-formed. One illustration of this phenomena is in FIG. 12C.

Continuing, after the complete expulsion of the composition from second chamber through the transition zone 34, and the withdrawal of the applicator 19 from the device 100e, the first cold-formed, internal surface 24 of second chamber 30 remains concave from the internal perspective, and the second cold-formed surface 25 of the second chamber 30 is deformed convex Or, both layers 12, 14 are round or something in between such as partly convex and partly concave, but always in nearly full surface contact with each other. By surface 24 and surface 25 having matching surface areas, the complete expulsion of composition 30 from chamber 30 is readily facilitated when surface 25 is deformed convexly to match and mate with surface 24 remaining in the concave configuration. This is possible because both surfaces 24, 25 were previously cold-formed. One illustration of this phenomena is in FIG. 12D. The configuration of the cold-formed foils further assist in the sustainability aspect of the device of the present invention and assist in reducing manufacturing costs overall.

Although both dental and orthodontic compositions are discussed above for use in device 10, other flowable compositions are also possible, such as perfume, lotions, lubricants, oils, paint, and permanent adhesives.

Various modifications and alterations to this disclosure will become apparent to those skilled in the art without departing from the scope and spirit of this disclosure. It should be understood that this disclosure is not intended to be unduly limited by the illustrative embodiments, aspects and examples set forth herein and that such examples, aspects, and embodiments are presented by way of example only with the scope of the disclosure intended to be limited only by the claims set forth herein as follows.

### Exemplary Aspects

Aspect 1 is a device for storing and dispensing a flowable dental composition, comprising: a first layer and a second layer, wherein the first layer and second layer form a first chamber for containing a flowable dental composition, a transition zone, and a second chamber; an applicator retained within the second chamber; wherein the first chamber has a first concave surface formed in the first layer and a second concave surface formed in the second layer; wherein the device includes an inactive state and an active state, wherein when in the inactive state, the substance is retained in the first chamber, and wherein when in the active state, a portion of the second surface is substantially non-reversibly deformed in response to pressure applied to the first chamber and the substance is thereby dispensed through the transition zone and into the second chamber.

Aspect 2 is the device of Aspect 1, wherein the first concave surface and second concave surface are cold-formed.

Aspect 3 is the device of Aspects 1-3 further including a light disruption portion.

Aspect 4 is the device of Aspect 3, wherein the first layer and second layer comprise a first clear layer, a second layer of metallic foil, and a third seal layer.

Aspect 5 is the device of Aspect 4, wherein the light disruption portion comprises a cut portion through the first layer and part of the second layer.

Aspect 6 is the device of Aspect 5, wherein one of the third seal layers comprise carbon black.

Aspect 7 is the device of Aspects 2-6, when the device is in an inactive state, the first cold-formed surface is concave and the second cold-formed surface is concave, when the device is in an active state, the first cold-formed surface remains concave and the second cold-formed surface is deformed convex and the flowable dental composition is thereby dispensed from the first chamber through the transition zone.

Aspect 8 is the device of Aspects 2-7, wherein a portion of the second cold-formed surface is substantially non-reversibly deformed in response to pressure applied to the first chamber and forms a smooth surface aligned with the first concave surface.

Aspect 9 is the device of Aspects 2-8 when the device is in an active state, the first cold-formed surface remains concave with no substantial wrinkles, and the second cold-formed surface is deformed with no substantial wrinkles into a convex surface.

Aspect 10 is the device of Aspects 1-9, wherein the first chamber is hermetically sealed along its entire circumference.

Aspect 11 is the device of Aspects 1-10, wherein a dispensing zone is connected to the second chamber, and where the dispensing zone retains a shaft of the applicator.

Aspect 12 is the device of Aspects 1-11, wherein the first and second layer are adhered together by heat sealed.

Aspect 13 is the device of Aspects 1-12, wherein the first and second layer are adhered together in the inactive state in the transition zone and around the first and second chambers.

Aspect 14 is the device of Aspect 13, wherein the transition zone has a reduced adherence between the first and second layers compared to the other areas around the first and second chambers.

Aspect 15 is the device of Aspects 1-14, wherein a brush head of the applicator is within the second chamber.

Aspect 16 is the device of Aspects 1-15, wherein a brush head of the applicator enters the transition zone during the active state.

Aspect 17 is the device of Aspect 1-16, wherein the dental composition is a cement, an adhesive, or a fluoride treatment.

Aspect 18 is the device for storing and dispensing a flowable dental composition, comprising: a first layer and a second layer, wherein the first layer and second layer form a first chamber, wherein the first chamber contains a flowable dental composition, a transition zone, and a second chamber; an applicator retained within the second chamber; wherein the first chamber has a first concave surface formed in the first layer and a second concave surface formed in the second layer; wherein the transition zone may be selectively opened by a pressure on the first chamber thereby allowing fluid communication between the first chamber, the transition zone and second chamber.

Aspect 19 is the device of Aspect 18, wherein the first concave surface and second concave surface is cold-formed.

Aspect 20 is the device of Aspects 18-19 further including a light disruption portion.

Aspect 21 is the device of Aspect 20, wherein the first layer and second layer comprise a first clear layer, a second layer of metallic foil, and a third seal layer.

Aspect 22 is the device of Aspect 21, wherein the light disruption portion comprises a cut portion through the first layer and part of the second layer.

Aspect 23 is the device of Aspect 22, wherein the third seal layers comprise carbon black.

Aspect 24 is the device of Aspects 19-23, when the device is in an inactive state, the first cold-formed surface is concave and the second cold-formed surface is concave, when the device is in an active state, the first cold-formed surface remains concave and the second cold-formed surface is deformed convex and the flowable dental composition is thereby dispensed from the first chamber through the transition zone.

Aspect 25 is the device of Aspects 19-24, wherein a portion of the second cold-formed surface is substantially non-reversibly deformed in response to pressure applied to the first chamber and forms a smooth surface aligned with the first concave surface.

Aspect 26 is the device of Aspects 19-25, when the device is in an active state, the first cold-formed surface remains concave with no substantial wrinkles, and the second cold-formed surface is deformed with no substantial wrinkles into a convex surface.

Aspects 27 is the device of Aspect 18-26, wherein the first chamber is hermetically sealed along its entire circumference.

Aspect 28 is the device of Aspects 18-27, wherein a dispensing zone is connected to the second chamber, and where the dispensing zone retains a shaft of the applicator.

Aspect 29 is the device of Aspects 18-28, wherein the first and second layer are adhered together by heat sealed.

Aspect 30 is the device of Aspects 18-29, wherein the first and second layer are adhered together in the inactive state in the transition zone and around the first and second chambers.

Aspect 31 is the device of Aspect 30, wherein the transition zone has a reduced adherence between the first and second layers compared to the other areas around the first and second chambers.

Aspect 32 is the device of Aspects 18-31 wherein a brush head of the applicator is within the second chamber.

Aspect 33 is the device of Aspects 18-32, wherein a brush head of the applicator enters the transition zone during the active state.

Aspect 34 is the device of Aspects 18-33, wherein the dental composition is a cement, an adhesive, or a fluoride treatment.

Aspect 35 is a device for storing and dispensing a flowable dental composition, comprising:
a first layer and a second layer, wherein the first layer and second layer form a first chamber containing a flowable dental composition, a second chamber, and a transition zone; and an applicator retained within the second chamber; wherein the first chamber has a first concave surface formed in the first layer and a second concave surface formed in the second layer; wherein the device includes an inactive state and an active state, wherein when in the inactive state, a first volume of the dental composition is retained in the first chamber, and wherein when in the active state, a second volume of the dental composition in the first chamber is less than the first volume.

Aspect 36 is the device of Aspect 35, where the second volume is 10% less of the first volume of the dental composition in the chamber.

Aspect 37 is the device of Aspect 35-36, wherein the first concave surface and second concave surface is cold-formed.

Aspect 38 is the device of Aspect 35-37 further including a light disruption portion.

Aspect 39 is the device of Aspect 38, wherein the first layer and second layer comprise a first clear layer, a second layer of metallic foil, and a third seal layer.

Aspect 40 is the device of Aspect 39, wherein the light disruption portion comprises a cut portion through the first layer and part of the second layer.

Aspect 41 is the device of Aspect 40, wherein one of the third seal layers comprise carbon black.

Aspect 42 is the device of Aspects 37-41, when the device is in an inactive state, the first cold-formed surface is concave and the second cold-formed surface is concave, when the device is in an active state, the first cold-formed surface remains concave and the second cold-formed surface is deformed convex and the flowable dental composition is thereby dispensed from the first chamber through the transition zone.

Aspect 43 is the device of Aspect 37-42, wherein a portion of the second cold-formed surface is substantially non-reversibly deformed in response to pressure applied to the first chamber and forms a smooth surface aligned with the first concave surface.

Aspect 44 is the device of Aspects 37-43, when the device is in an active state, the first cold-formed surface remains concave with no substantial wrinkles, and the second cold-formed surface is deformed with no substantial wrinkles into a convex surface.

Aspect 45 is the device of Aspects 35-44, wherein the first chamber is hermetically sealed along its entire circumference.

Aspect 46 is the device of Aspects 35-45, wherein a dispensing zone is connected to the second chamber, and where the dispensing zone retains a shaft of the applicator.

Aspect 47 is the device of Aspects 35-46, wherein the first and second layer are adhered together by heat sealed.

Aspect 48 is the device of Aspects 35-47, wherein the first and second layer are adhered together in the inactive state in the transition zone and around the first and second chambers.

Aspect 49 is the device of Aspect 48, wherein the transition zone has a reduced adherence between the first and second layers compared to the other areas around the first and second chambers.

Aspect 50 is the device of Aspects 35-49, wherein a brush head of the applicator is within the second chamber.

Aspect 51 is the device of Aspects 35-50, wherein a brush head of the applicator enters the transition zone during the active state.

Aspect 52 is the device of Aspects 35-51, wherein the dental composition is a cement, an adhesive, or a fluoride treatment.

Aspect 53 is a device for storing and dispensing a flowable dental composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; and a light disruption portion for protecting the flowable dental composition from prematurely curing.

Aspect 54 is the device of Aspect 53 further including a light disruption portion.

Aspect 55 is the device of Aspect 54, wherein the first layer and second layer comprise a first clear layer, a second layer of aluminum, and a third seal layer.

Aspect 56 is the device of Aspect 55, wherein the light disruption portion comprises a cut portion through the first layer and part of the second layer.

Aspect 57 is the device of Aspect 56, wherein the third seal layers comprise carbon black.

Aspect 58 is the device of Aspect 53-57, wherein the first and second layer comprise metal, and wherein the metal is fused together with high heat and serve as the light disruption portion.

Aspect 59 is the device of Aspects 53-57, wherein the first chamber has a first concave surface and a second concave surface.

Aspect 60 is the device of Aspects 53-59, wherein the first concave surface and second concave surface is cold-formed.

Aspect 61 is the device of Aspects 53-60, wherein the device includes an inactive state and an active state, wherein when in the inactive state, the substance is retained in the chamber, and wherein when in the active state, a portion of the second convex surface is substantially non-reversibly deformed in response to pressure applied to the first chamber and the substance is thereby dispensed through the transition zone and into the second chamber.

Aspect 62 is the device of Aspects 55-61, when the device is in an inactive state, when the device is in an active state, the first convex surface remains concave and the second cold-formed surface is deformed from concave to convex and the flowable dental composition is thereby dispensed from the first chamber through the transition zone.

Aspect 63 is the device of Aspect 55-62, wherein a portion of the second surface is substantially non-reversibly deformed in response to pressure applied to the first chamber and forms a smooth surface aligned with the first concave surface.

Aspect 64 is the device of Aspects 55-63, when the device is in an active state, the first surface remains concave with no substantial wrinkles, and the second surface is deformed with no substantial wrinkles into a convex surface.

Aspect 65 is the device of Aspects 55-64, wherein the first chamber is hermetically sealed along its entire circumference.

Aspect 66 is the device of Aspects 55-65, wherein a dispensing zone is connected to the second chamber, and where the dispensing zone retains a shaft of the applicator.

Aspect 67 is the device of Aspects 55-66, wherein the first and second layer are adhered together by heat sealed.

Aspect 68 is the device of Aspects 55-67, wherein the first and second layer are adhered together in the inactive state in the transition zone and around the first and second chambers.

Aspect 69 is the device of Aspect 68, wherein the transition zone has a reduced adherence between the first and second layers compared to the other areas around the first and second chambers.

Aspect 70 is the device of Aspect 66-69, wherein a brush head of the applicator is within the second chamber.

Aspect 71 is the device of Aspects 66-70, wherein a brush head of the applicator enters the transition zone during the active state.

Aspect 72 is the device of Aspects 66-71, wherein the dental composition is a cement, an adhesive, or a fluoride treatment.

Aspect 73 is a device for storing and dispensing a flowable dental composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; wherein the second concave surface is substantially non-reversibly deformed in response to pressure applied to the first chamber and forms a smooth convex surface aligned with the first concave surface.

Aspect 74 is the device of Aspect 73, wherein the device includes an inactive state and an active state, wherein when in the inactive state, the substance is retained in the chamber, and wherein when in the active state, a portion of the second concave surface is substantially non-reversibly deformed in response to pressure applied to the first chamber and the substance is thereby dispensed through the transition zone and into the second chamber.

Aspect 75 is the device of Aspects 73-74, wherein the first concave surface and second concave surface is cold-formed.

Aspect 76 is the device of Aspects 73-75 further including a light disruption portion.

Aspect 77 is the device of Aspect 76, wherein the first layer and second layer comprise a first clear layer, a second layer of aluminum, and a third seal layer.

Aspect 78 is the device of Aspects 66-77, wherein the light disruption portion comprises a cut portion through the first layer and part of the second layer.

Aspect 79 is the device of Aspect 78, wherein one of the third seal layers comprise carbon black.

Aspect 80 is the device of Aspects 75-79, when the device is in an inactive state, the first cold-formed surface is concave and the second cold-formed surface is concave, when the device is in an active state, the first cold-formed surface remains concave and the second cold-formed surface is deformed convex and the flowable dental composition is thereby dispensed from the first chamber through the transition zone.

Aspect 81 is the device of Aspects 75-80, wherein a portion of the second cold-formed surface is substantially non-reversibly deformed in response to pressure applied to the first chamber and forms a smooth surface aligned with the first concave surface.

Aspect 82 is the device of Aspects 75-81, when the device is in an active state, the first cold-formed surface remains concave with no substantial wrinkles, and the second cold-formed surface is deformed with no substantial wrinkles into a convex surface.

Aspect 83 is the device of Aspects 73-82, wherein the first chamber is hermetically sealed along its entire circumference.

Aspect 84 is the device of Aspects 73-83, wherein a dispensing zone is connected to the second chamber, and where the dispensing zone retains a shaft of the applicator.

Aspect 85 is the device of Aspects 73-84, wherein the first and second layer are adhered together by heat sealed.

Aspect 86 is the device of Aspects 73-85, wherein the first and second layer are adhered together in the inactive state in the transition zone and around the first and second chambers.

Aspect 87 is the device of Aspect 86, wherein the transition zone has a reduced adherence between the first and second layers compared to the other areas around the first and second chambers.

Aspect 88 is the device of Aspects 73-87, wherein a brush head of the applicator is within the second chamber.

Aspect 89 is the device of Aspects 73-88, wherein a brush head of the applicator enters the transition zone during the active state.

Aspect 90 is the device of Aspects 73-89, wherein the dental composition is a cement, an adhesive, or a fluoride treatment.

Aspect 91 is a device for storing and dispensing a flowable orthodontic composition, comprising: a first layer and a second layer, wherein the first layer and second layer form a first chamber for containing a flowable dental composition, a transition zone, and a second chamber; an applicator retained within the second chamber; wherein the first chamber has a first concave surface formed in the first layer and a second concave surface formed in the second layer; wherein the device includes an inactive state and an active state, wherein when in the inactive state, the substance is retained in the first chamber, and wherein when in the active state, a portion of the second surface is substantially non-reversibly deformed in response to pressure applied to the first chamber and the substance is thereby dispensed through the transition zone and into the second chamber.

Aspect 92 is a device for storing and dispensing a flowable orthodontic composition, comprising: a first layer and a second layer, wherein the first layer and second layer form a first chamber, wherein the first chamber contains a flowable dental composition, a transition zone, and a second chamber; an applicator retained within the second chamber; wherein the first chamber has a first concave surface formed in the first layer and a second concave surface formed in the second layer; wherein the transition zone may be selectively opened by a pressure on the first chamber thereby allowing fluid communication between the first chamber, the transition zone and second chamber.

Aspect 93 is a device for storing and dispensing a flowable orthodontic composition, comprising: a first layer and a second layer, wherein the first layer and second layer form a first chamber containing a flowable dental composition, a second chamber, and a transition zone; and an applicator retained within the second chamber; wherein the first chamber has a first concave surface formed in the first layer and a second concave surface formed in the second layer; wherein the device includes an inactive state and an active state, wherein when in the inactive state, a first volume of the dental composition is retained in the first chamber, and wherein when in the active state, a second volume of the dental composition in the first chamber is less than the first volume.

Aspect 94 is a device for storing and dispensing a flowable orthodontic composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; and a light disruption portion for protecting the flowable dental composition from prematurely curing.

Aspect 95 is a device for storing and dispensing a flowable orthodontic composition, comprising: a first layer and a second layer, wherein the first layer and second layer form a first chamber for containing a flowable dental composition, a transition zone, and a second chamber; wherein the first chamber has a first concave surface formed in the first layer and a second concave surface formed in the second layer; an applicator retained within the second chamber; wherein the second concave surface is substantially non-reversibly deformed in response to pressure applied to the first chamber and forms a smooth convex surface aligned with the first concave surface.

Aspect 96 is method of making a device for storing and dispensing a flowable dental or orthodontic composition, comprising: providing a first layer; cold forming the first layer, thereby partially forming a first and second chambers; filling of the first chamber with the flowable dental or orthodontic composition; providing a second layer; cold forming the second layer, thereby partially forming the first and second chambers; sealing the second layer to the first layer in surface-area contact, leaving the first and second chambers open, forming a dispensing zone, and forming a transition zone that can be selectively opened between the first and second chambers and in the dispensing zone; dye cutting the desired shape of the device; and partially cutting the first and second layers with a cut for a light disruption portion.

Aspect 97 is the device of Aspects 1-95 further comprising a dispensing zone formed between the first layer and the second layer, wherein the dispending zone comprises a first flow barrier and a second flow barrier.

Aspect 98 is the device of Aspect 97, wherein the first flow barrier and second flow barrier are configured in the shape of a wave.

Aspect 99 is the device of Aspects 1-95 further comprising a dispensing zone, wherein when in the active state, a portion of the second surface is substantially non-reversibly deformed in response to pressure applied to the second chamber and the substance is thereby dispensed through the dispensing zone from the second chamber.

1. A device for storing and dispensing a flowable dental composition, comprising:
a first layer and a second layer, wherein the first layer and second layer form a first chamber for containing a flowable dental composition, a transition zone, and a second chamber;
an applicator retained within the second chamber;
wherein the first chamber has a first concave surface formed in the first layer and a second concave surface formed in the second layer;
wherein the device includes an inactive state and an active state, wherein when in the inactive state, the substance is retained in the first chamber, and wherein when in the active state, a portion of the second surface is substantially non-reversibly deformed in response to pressure applied to the first chamber and the substance is thereby dispensed through the transition zone and into the second chamber.

2. The device of claim 1, wherein the first concave surface and second concave surface are cold-formed.

3. The device of claim 1 further including a light disruption portion.

4. The device of claim 3, wherein the first layer and second layer comprise a first clear layer, a second layer of metallic foil, and a third seal layer comprising carbon black.

5. The device of claim 4, wherein the light disruption portion comprises a cut portion through the first layer and part of the second layer.

6. (canceled)

7. The device of claim 2, when the device is in an inactive state, the first cold-formed surface is concave and the second cold-formed surface is concave, when the device is in an active state, the first cold-formed surface remains concave and the second cold-formed surface is deformed convex and the flowable dental composition is thereby dispensed from the first chamber through the transition zone.

8. The device of claim 2, wherein a portion of the second cold-formed surface is substantially non-reversibly deformed in response to pressure applied to the first chamber and forms a smooth surface aligned with the first concave surface.

9. The device of claim 2, when the device is in an active state, the first cold-formed surface remains concave with no substantial wrinkles, and the second cold-formed surface is deformed with no substantial wrinkles into a convex surface.

10-17. (canceled)

18. A device for storing and dispensing a flowable dental composition, comprising:
a first layer and a second layer, wherein the first layer and second layer form a first chamber, wherein the first chamber contains a flowable dental composition, a transition zone, and a second chamber;
an applicator retained within the second chamber;
wherein the first chamber has a first concave surface formed in the first layer and a second concave surface formed in the second layer;
wherein the transition zone may be selectively opened by a pressure on the first chamber thereby allowing fluid communication between the first chamber, the transition zone and second chamber.

19. The device of claim 18, wherein the first concave surface and second concave surface is cold-formed.

20. The device of claim 18 further including a light disruption portion.

21. The device of claim 20, wherein the first layer and second layer comprise a first clear layer, a second layer of metallic foil, and a third seal layer.

22-23. (canceled)

24. The device of claim 19, when the device is in an inactive state, the first cold-formed surface is concave and the second cold-formed surface is concave, when the device is in an active state, the first cold-formed surface remains concave and the second cold-formed surface is deformed convex and the flowable dental composition is thereby dispensed from the first chamber through the transition zone.

25. The device of claim 19, wherein a portion of the second cold-formed surface is substantially non-reversibly deformed in response to pressure applied to the first chamber and forms a smooth surface aligned with the first concave surface.

26. The device of claim 19, when the device is in an active state, the first cold-formed surface remains concave with no substantial wrinkles, and the second cold-formed surface is deformed with no substantial wrinkles into a convex surface.

27-32. (canceled)

33. The device of claim 18, wherein a brush head of the applicator enters the transition zone during the active state.

34-95. (canceled)

96. A method of making a device for storing and dispensing a flowable dental or orthodontic composition, comprising:
providing a first layer;
cold forming the first layer, thereby partially forming a first and second chambers;
filling of the first chamber with the flowable dental or orthodontic composition;
providing a second layer;
cold forming the second layer, thereby partially forming the first and second chambers;
sealing the second layer to the first layer in surface-area contact, leaving the first and second chambers open, forming a dispensing zone, and forming a transition zone that can be selectively opened between the first and second chambers and in the dispensing zone;
dye cutting the desired shape of the device; and
partially cutting the first and second layers with a cut for a light disruption portion.

97. The device of claim 1 further comprising a dispensing zone formed between the first layer and the second layer, wherein the dispending zone comprises a first flow barrier and a second flow barrier.

98. The device of claim 97, wherein the first flow barrier and second flow barrier are configured in the shape of a wave.

99. (canceled)
